(19) United States
(12) Patent Application Publication
(10) Pub. No.: US 2013/0089080 A1
(43) Pub. Date: Apr. 11, 2013

(54) DATA MERGING FOR BLUETOOTH DEVICES

(71) Applicant: Steven Singer, Cambridge (GB)

(72) Inventor: Steven Singer, Cambridge (GB)

(73) Assignee: CAMBRIDGE SILICON RADIO LIMITED, Cambridge (GB)

(21) Appl. No.: 13/267,390

(22) Filed: Oct. 6, 2011

(51) Int. Cl. H04W 80/00

(52) U.S. Cl. 370/338

(57) ABSTRACT

A method for performance in a device having a first processing system for providing the functionality of the upper layers of a Bluetooth stack and a Bluetooth Controller for providing the functionality of the lower layers of the Bluetooth stack, the first processing system and the Bluetooth Controller being connected by a Host Controller Interface (HCI), the method including the steps of generating L2CAP packets in the L2CAP layer of the Bluetooth stack in the first processing system corresponding to an Asynchronous Connectionless (ACL) link, transmitting those L2CAP packets through the Bluetooth stack to the Bluetooth Controller via the HCI, inserting data generated in a second processing system into the L2CAP packets in the Bluetooth Controller, and transmitting the L2CAP packets over the ACL link.

### BACKGROUND

The current invention relates to techniques for merging data for transmission within a Bluetooth system, and in particular to techniques for performing such merging at layers below the L2CAP layer.

The Bluetooth radio system is a set of standards defining the operation of radio devices such that communication can be established between devices in a standardised fashion.

As part of the Bluetooth standards, the Bluetooth stack is defined, which is a set of layers through which data is passed, each layer performing particular functions to ensure a communications link functions. The layers of the stack may be implemented in a single device, but may also be split between devices.

It is a common requirement to share a single Bluetooth radio link between different data sources or sinks The L2CAP layer of the Bluetooth stack provides for the multiplexing of data onto a single radio link. However, if the Bluetooth stack is split across more than one device, the L2CAP layer may be implemented in a device which cannot conveniently accept data from other devices for multiplexing.

There is a therefore a requirement for a technique to allow multiplexing on a Bluetooth link without requiring access to the L2CAP layer of the Bluetooth stack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method for performance in a device having a first processing system for providing the functionality of the upper layers of a Bluetooth stack and a Bluetooth Controller for providing the functionality of the lower layers of the Bluetooth stack, the first processing system and the Bluetooth Controller being connected by a Host Controller Interface (HCI), the method comprising the steps of generating L2CAP packets in the L2CAP layer of the Bluetooth stack in the first processing system corresponding to an Asynchronous Connectionless (ACL) link, transmitting those L2CAP packets through the Bluetooth stack to the Bluetooth Controller via the HCI, inserting data generated in a second processing system into the L2CAP packets in the Bluetooth Controller, and transmitting the L2CAP packets over the ACL link.

A selection of optional features of the claims are set out in the dependent claims. The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a diagram of the Bluetooth stack;

FIG. 2 shows a diagram of a Bluetooth stack split between the two devices at the HCI layer;

FIG. 3 shows a schematic diagram of a device having a Bluetooth stack between two devices;

FIG. 4 shows a schematic diagram of a device allowing multiplexing below the L2CAP layer;

FIG. 5 shows a flow chart of a method of operating the system of FIG. 4;

FIG. 6 shows a flow chart of a further method utilising payloads of zero length;

FIG. 7 shows a flow chart of a further method in which timing control is moved partly to the Bluetooth device;

FIG. 8 shows a schematic diagram of a further device in which multiplexing below the L2CAP layer can be performed;

FIG. 9 shows a flow chart of a method of insulating audio playback over a Bluetooth link;

FIG. 10 shows a further method for multiplexing data into a Bluetooth stack;

FIG. 11 shows a flow chart of a further method comparable to that of FIG. 6;

FIG. 12 shows a further method comparable to the method of FIG. 7;

FIG. 13 shows a method of multiplexing data onto the Bluetooth stack; and

FIG. 14 shows a method of transition to avoid termination. Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

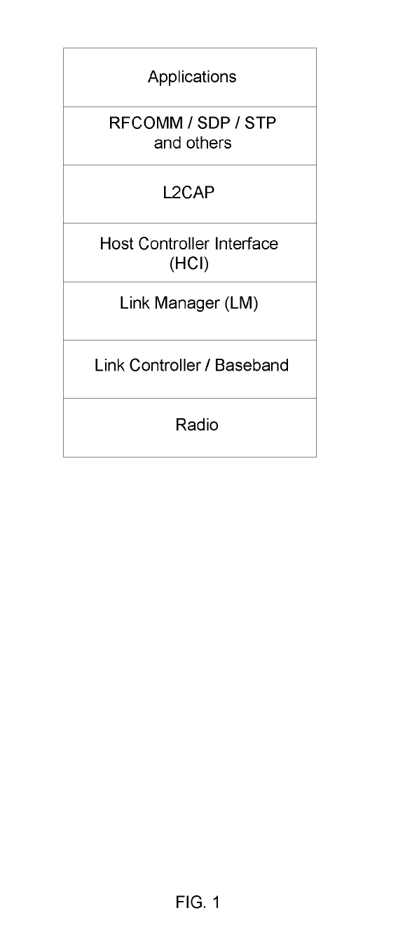

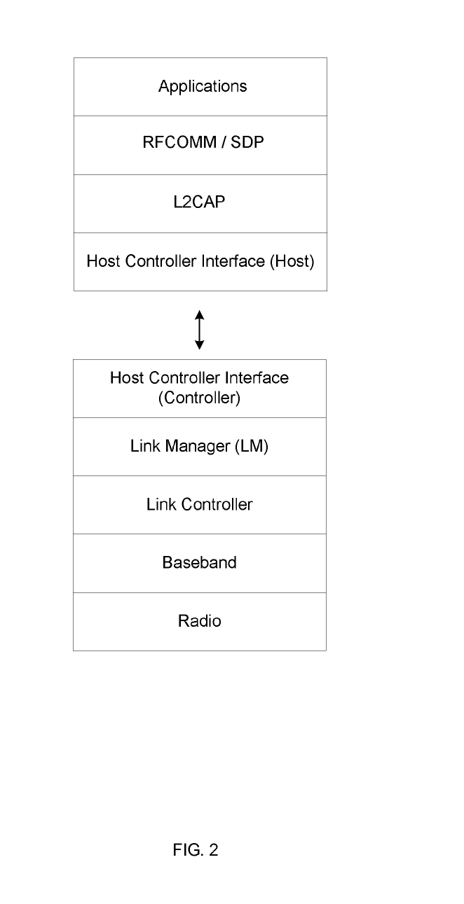

FIG. 1 shows a diagram of the Bluetooth stack. FIG. 2 shows a diagram of a Bluetooth stack implementation in which the L2CAP and higher layers are located on a host processor and the lower layers are located on a separate processor, for example a microchip providing Bluetooth services (the Bluetooth controller). The two layers are connected by the host Controller Interface (HCI).

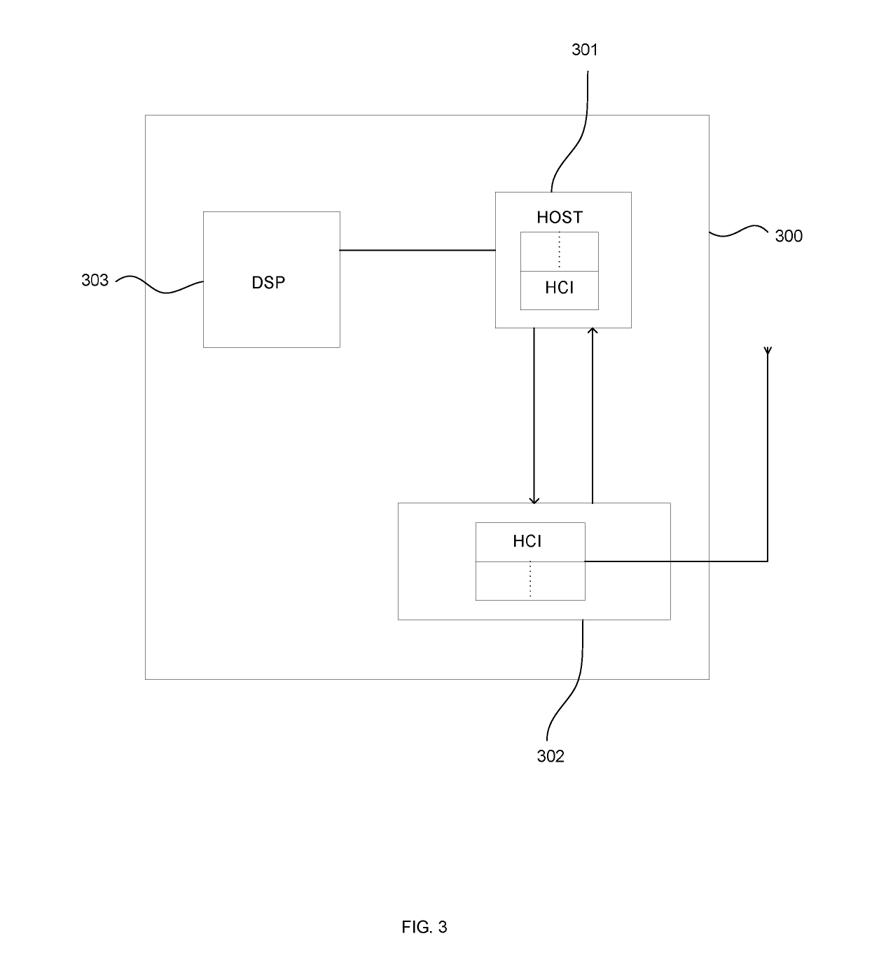

FIG. 3 shows a schematic diagram of a device on which the stack implementation of FIG. 2 may be utilized. A device 300 comprises a host processor 301, a Bluetooth controller 302 and a DSP 303. The host processor 301 is a general purpose processor for providing the device, for example a mobile telephone, with its functionality. The general purpose host processor 301 may be inefficient at particular tasks, for example decoding compressed audio for playback over a Bluetooth link. However, the DSP 303 can be configured to perform such tasks more efficiently, thereby decreasing power consumption. In order to transmit the decoded audio information (or other data generated by the DSP 303) via the Bluetooth link, the DSP 303 requires access to the Bluetooth stack at an appropriate layer to multiplex the audio data into the Bluetooth data flow. The L2CAP layer is the logical point in a Bluetooth system to perform this multiplexing, since that layer is responsible for forming data links with remote devices. However, that layer resides on the host processor, and so the DSP must be connected to the host, and the host must be active to accept and process the data.

While the DSP 303 is being used for audio playback, it is possible that the host processor is performing very little, or no, other processing and so could be partially or fully sent to sleep to conserve power. However, the host must remain awake to provide the L2CAP functionality for multiplexing. As explained above, there is therefore a need for a technique to allow multiplexing below the L2CAP layer. This is generally not simple to implement because data links in the Bluetooth standard are 1:1 below the L2CAP layer thereby making multiplexing into those data links difficult whilst maintaining flow-control and link integrity.

A possible method would be to perform multiplexing in the HCI layer. However, such an approach is unattractive because to ensure data is routed correctly packets and acknowledgements must be tagged requiring additional processing to correctly route the packets to the right L2CAP entity. Furthermore, HCI and L2CAP packets do not necessarily correspond, and therefore to ensure L2CAP packets are not split, L2CAP headers must be read by the multiplexing device to ensure data from the other devices is inserted at the correct point. In addition, Bluetooth defines a flow control mechanism to be used over HCI. This is needed to limit the host's consumption of memory on the controller. The specifics of this flow control mechanism make it difficult to dynamically partition controller memory to multiple data sources.

The techniques described below provide alternative solutions to the multiplexing of data into a Bluetooth link. Modification of discrete parts of the system allows the multiplexing techniques to be performed, resulting in a more efficient system.

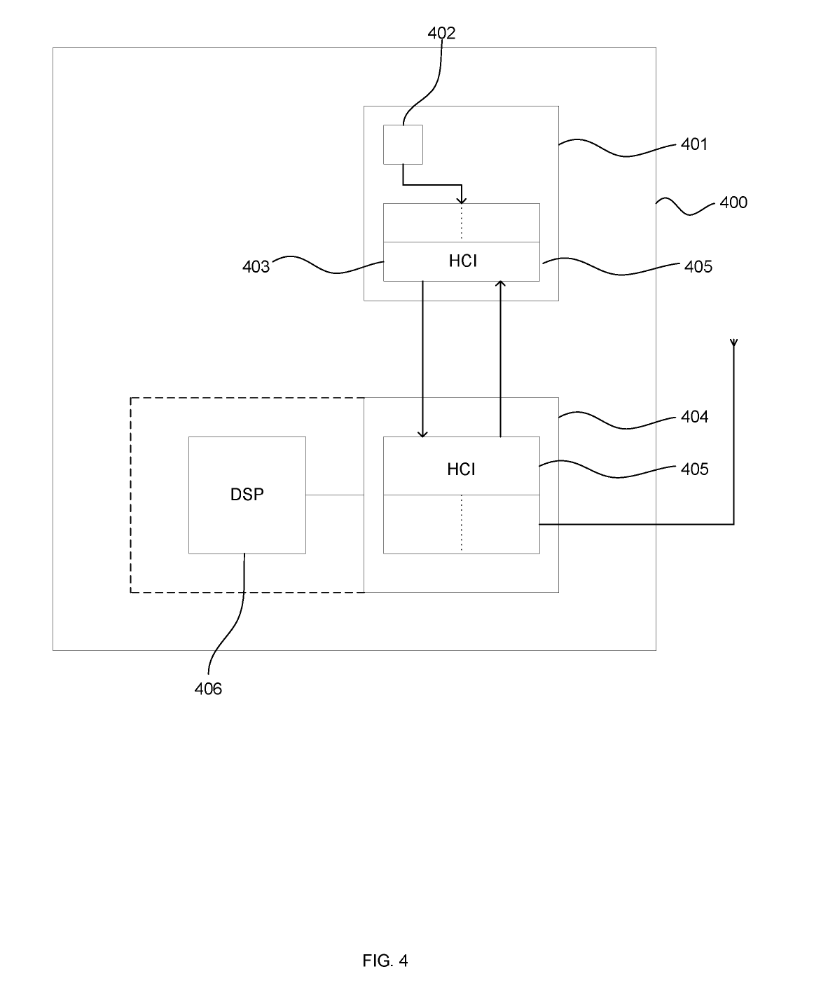

FIG. 4 shows a schematic diagram of a device 400 for the implementation of the techniques described below. Host processor 401 comprises the layers of the Bluetooth stack 403 from L2CAP upwards, and a processing application 402 for providing data to the Bluetooth stack for transmission over a Bluetooth link. For example, the processing application may be for processing compressed audio data for transmission over a Bluetooth link. Processing application 402 may pass its output data to the Bluetooth stack for processing and transmission in the standard manner.

The host processor is connected to Bluetooth controller 404 by the HCI 405. Bluetooth controller 404 also provides the lower levels of the Bluetooth stack. A DSP 406 is provided for performing customized processing. DSP 406 may be provided as part of the same package or processor as the Bluetooth controller 404, or may be separate. The use of the term DSP is not intended to restrict that device to any particular type of processor. Any device(s) suitable for providing the controller and/or DSP functionality may be utilised to implement those components. DSP 406 is connected to the Bluetooth controller 404 to allow transmission of data between the DSP and the controller 404 for transmission over the Bluetooth link.

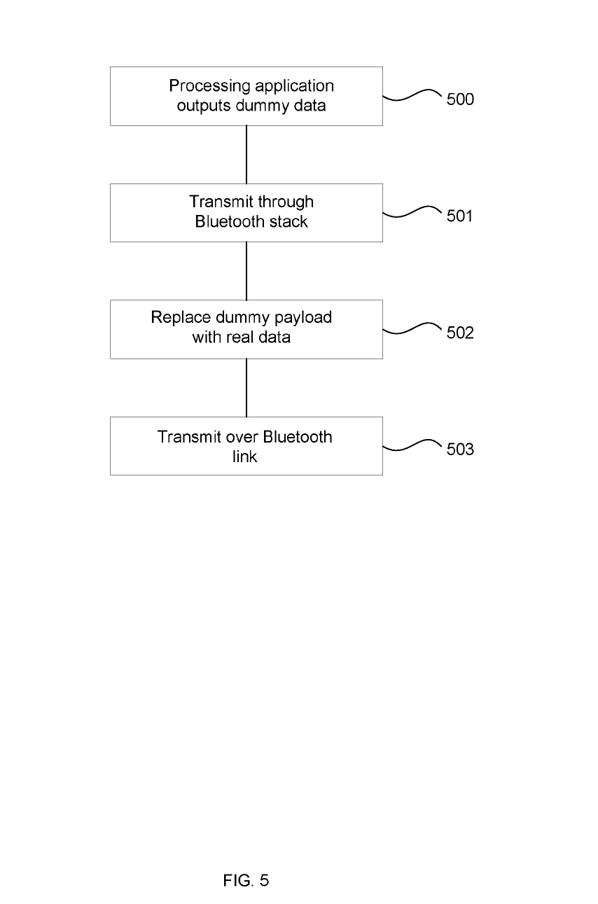

FIG. 5 shows a first method of operating the system of FIG. 4 to enable the multiplexing of data from the host and DSP onto a Bluetooth link.

The processing application 402 of the host 401 is modified such that rather than outputting processed data, it outputs dummy data (Block 500). For example, the payloads may be formed as all-zeros, as a pre-defined data pattern, or as garbage. As the dummy data is passed through the Bluetooth stack it is treated in the standard manner and formed into packets with appropriate headers. No modification is made to the behaviour of the upper Bluetooth layers of the stack, including the host implementation of the HCI, and the layers are not aware that the data is not real.

The Bluetooth controller 406 monitors data flow from the host in order to identify dummy data from the processing application 402. When such data is identified, it is replaced (Block 502) by real data from the DSP 406. Two exemplary ways to identify the data to be replaced are (1) to select the dummy data output by the processing application such that it is a unique sequence that cannot occur in other parts of the data stream; and (2) to analyse the packet structure to identify the payload part of the frames containing dummy data. It is important to identify the correct data otherwise the wrong sections would be replaced. The DSP 406 and processing application 402 are configured such that their output data rates match, and therefore there can be a direct replacement of the data from the processing application 402 with the real data from the DSP 406. For example, the DSP could automatically adapt the rate at which it produces data to match the rate of the processing application as indicated by that application or as determined from the dummy data identified in the controller. The packets carrying the real data are then transmitted over the Bluetooth link in the conventional manner (Block 503).

Data from the DSP 406 has therefore been multiplexed into the Bluetooth link without requiring access to the L2CAP on the host and avoiding multiplexing in the HCI. Any real data from the host (for example from a 2nd application) is not affected by the method as the packets will not be identified for replacement and they will therefore be transmitted conventionally. The packet headers are not changed by the process and the receiving device is not aware that any change has occurred. Since the L2CAP layer is unchanged, no problems with packet ordering or interleaving are caused when 2 data sources operate.

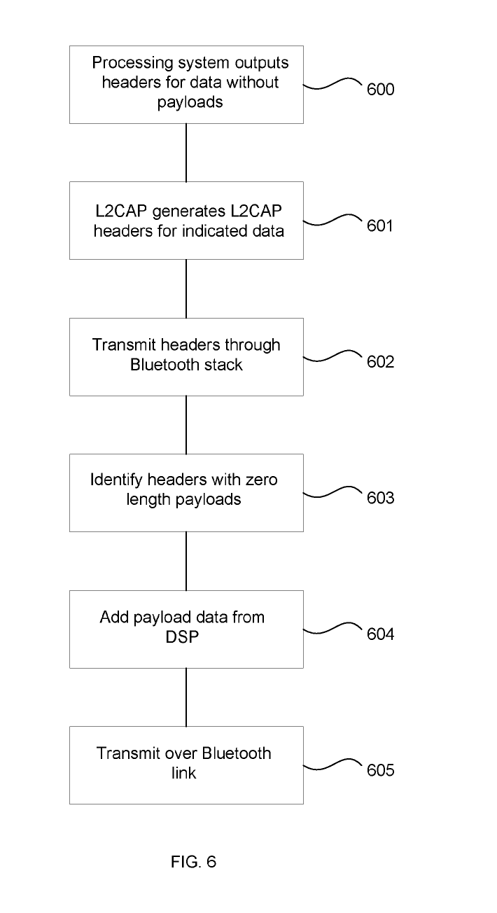

In the example described with reference to FIG. 5, the data from the processing application 402 is only dummy data which is not used other than to identify the data for direct replacement. FIG. 6 shows a modification of the method of FIG. 5 in which payloads of zero length are generated. The method of FIG. 6 is also applicable to the system shown in FIG. 4.

To implement the method of FIG. 6 the processing application 402 is modified not to output actual data, but rather to output an indication of the data it would have generated if operating normally (Block 600). For example, it may output an indication that it would have output a packet of 600 bytes, but that indication may be a message of only a few bytes. A modified L2CAP layer receives the indication and calculates the number of HCI packets that would have been required to contain that amount of data from the processing application 402. The L2CAP layer generates the appropriate number of packets for transmission through the Bluetooth stack (Block 601). For example, if the maximum payload of an HCI packet is 300 bytes, two packets for containing 300 bytes would be generates to accommodate the indicated 600 bytes of data. These HCI packets do not carry any actual data and therefore lower levels of the stack may require modification since their actual length will not match their indicated length.

The packets are transmitted (Block 602) through the Bluetooth stack to the Bluetooth controller 404. The headers having zero-length payloads are identified (Block 603) in the Bluetooth controller 404 and data from the DSP is inserted (Block 604) into those packets to form packets matching the length indicated by the headers. The completed packets are transmitted over the Bluetooth link at Block 605.

In this method less data is generated by the processing application and transmitted over the HCI from the host device to the Bluetooth controller. This may lead to a power saving, and also reduces the bandwidth required by that link. As in the previous method, multiplexing onto the Bluetooth link is accomplished at a layer below L2CAP and without affecting the HCI.

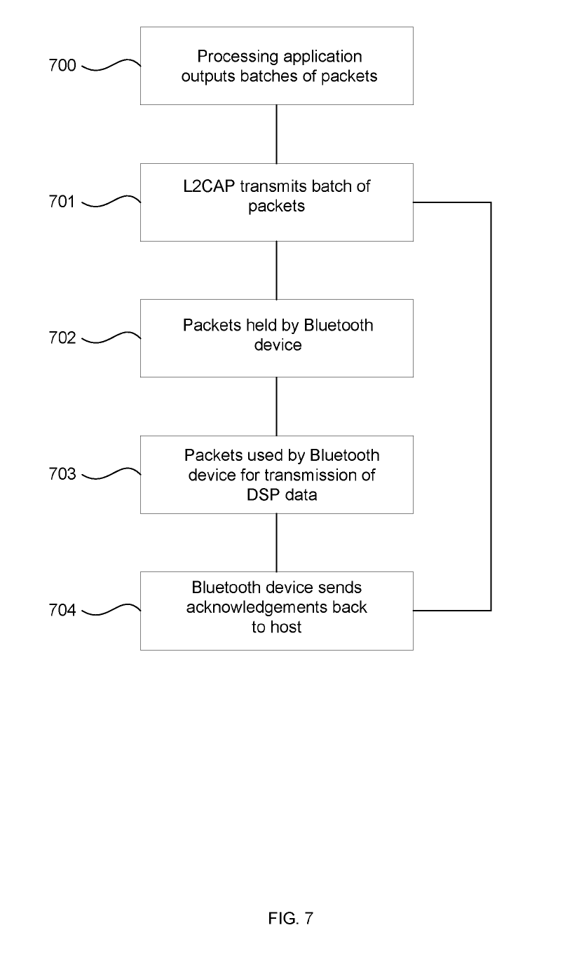

FIG. 7 shows a further method of multiplexing in which timing control is moved partly to the Bluetooth device. This may provide greater flexibility and may allow the host to sleep for extended periods of time.

The processing application is modified to output the correct average data rate, but to output packets in batches (Block 700). For example, rather than outputting a 600 byte packet (or indication thereof) every 20 ms, four 600 byte packets (or indications thereof) may be output every 80 ms. The L2CAP layer receives these and issues the appropriate number of HCI packets as described previously (Block 701).

The Bluetooth controller receives the packets (Block 702), and uses them over time, as described previously, by inserting data from the DSP 408 and transmitting the data over the Bluetooth link (Block 703). However, no acknowledgements are returned to the host immediately.

When the Bluetooth device comes towards the end of its supply of packets it transmits a batch of acknowledgements back to the host (Block 704). The host 401 processes those acknowledgements to retain awareness of the state of the link. The method then returns to Block 701 for the next batch of packets.

The Bluetooth controller is thus supplied with packets at the correct average rate for transmission of the DSP data, but those packets are transmitted, and acknowledgements received, by the host 401 in batches. The host 401 can therefore sleep for extended periods between batches.

The number of packets transmitted in each batch by the host 401 must be controlled such that the host does not lose the ability to transmit its own data via the Bluetooth link. For example, other applications on the host may also wish to transmit data. If all available packets which the Bluetooth stack can sustain are sent to the Bluetooth controller, the host cannot send any more data until an acknowledgement is received. If there is a delay in data transmission over the link it may be some time before an acknowledgment is returned to the host 401 to allow it to transmit. It may therefore be desirable for the host 401 to retain an overhead for its own use.

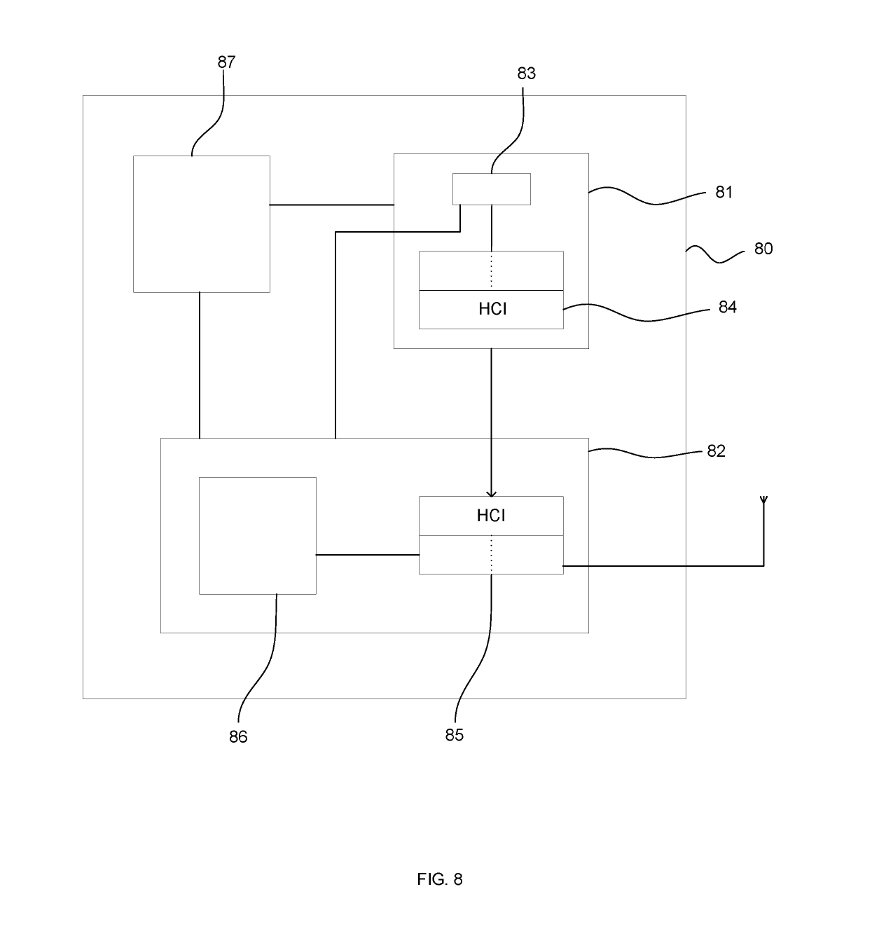

Specific examples will be provided to further describe the methods introduced above. These examples will be described with reference to the device 80 shown in FIG. 8.

Device 80 may be a mobile device, for example a mobile telephone. The device 80 comprises a host processor 81 for providing functionality of the device. The host processor 81 is provided with applications 83 for providing that functionality and an implementation 84 of the upper layers of a Bluetooth stack, down to the L2CAP layer and a HCI 84 for interfacing to DSP 82.

DSP 82 is provided, which processor comprises an implementation 85 of the lower levels of a Bluetooth stack, from the controller HCI downwards. For convenience the term DSP is used for processor 82, but as will be appreciated any type of processor suitable for providing the required functionality could be utilised. Furthermore, the functionality of the DSP may be provided by Bluetooth controller, or as part of the same processor providing the controller functionality. The DSP may therefore be provided by a logically and physically separate device, or as part of the same device as the controller.

Implementations 84 and 85 communicate to provide full Bluetooth functionality. DSP 82 is selected to provide specific functions and thus is likely to be smaller and more power efficient for many tasks than the host processor. The DSP 82 may therefore be configured to perform specific tasks much more efficiently than is possible in the host processor 81. For example, DSP 82 may be provided with an audio decoding application 86 for decoding encoded audio files for transmission over a Bluetooth link.

Host 81 and DSP 82 are connected to, and can access, a storage device 87. Access to that storage device by the DSP 81, 82 and host may be provided using the methods and techniques described in co-pending UK application 0805220.1. The details of the access methods and techniques disclosed therein are incorporated herein by reference and are disclosed in combination with all disclosure made in this application. Storage device 82 maybe removable solid state device (for example, an SD card), or could be conventional RAM. Any storage device may be utilised as appropriate.

In conventional devices an application 83 on the host processor 81 would be utilised to decode audio files, but the use of the host for such a function is very inefficient. As explained previously, in order for the decoding of audio files, and transmission via Bluetooth, to be performed most efficiently by allowing the host to shut down, a method of multiplexing data into the Bluetooth link at the controller HCI or lower is needed. General methods for accomplishing this have been described above and further example methods are described below.

DSP 82 is provided with an audio processing application 86 which is connected to an application 83 on the host processor. FIG. 8 shows the connection as a discrete connection, but it may also be shared with other communications links between the host 82 and DSP 82 and may be implemented physically or logically. DSP application 86 is utilised to perform the actual decoding of the audio file. Host application 83 provides user interface and control functions and outputs certain data to the Bluetooth stack 84 to facilitate the insertion of data from application 86. The application 83 may be based on a conventional audio decoding application providing equivalent functionality to application 86. Application 83 is preferably produced in a modular manner such that certain sections can easily be modified, for example, the processing part of the application 85 can be replaced with a dummy module, and the user interface module of application 86 can be omitted.

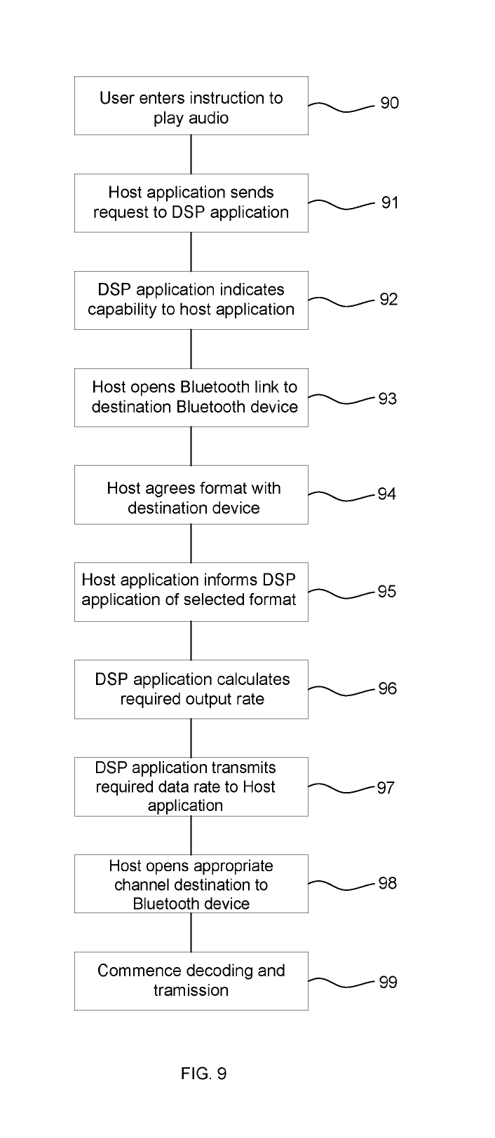

Applications 86, 87 cooperate to provide decoding and transmission of an audio file over a Bluetooth link. FIG. 9 shows a flow chart of a method of initiating audio play back over a Bluetooth link utilising application 86.

At block 90 the user enters instructions to the device that they wish to play a particular audio file over a Bluetooth link to a destination device. The user interface to allow this instruction is provided by the host 81. At block 91 the host application 83 sends the request to DSP application 86. At block 92 the DSP application 86 transmits an indication of the services it can provide for the playing of the particular file, for example the formats in which it can output the decoded data.

The host 81 opens a link to the destination device at block 93, and agrees with the destination device which of the available services will be utilised for the transmission (Block 94). For example, the DSP application 86 may be capable of outputting a number of data formats, but the destination device may only be capable of receiving SBC encoded data, in which case that option would be selected. The selection of services may alternatively be configured in advance, or may utilise input from the user to select the services, in which some or all of these steps may be omitted

At block 95 the host application 83 informs the DSP application 86 of the selected services. The DSP application 86 calculates the required output data rate at block 96 and transmits that rate to the host application 83 at block 97. In an alternative method, the calculation of data rate may be performed by the host processor 81, in which case the DSP application 86 is informed of the required output format, but does not calculate the rate or transmit it.

At block 98 the host application 83 then opens an Asynchronous Connectionless (ACL) Bluetooth link to the destination device for the transmission of the decoded data. At block 99 decoding and transmission commences. The connection between the host application 83 and the DSP application 86 may be utilised to control the DSP application 86 in response to user commands accepted by the host application. For example, start/stop or track-skip instructions may be given by the user and passed to the DSP application 86 by the host application 83. The device 80 is thus configured to beg in the transmission of decoded audio data to the destination in device.

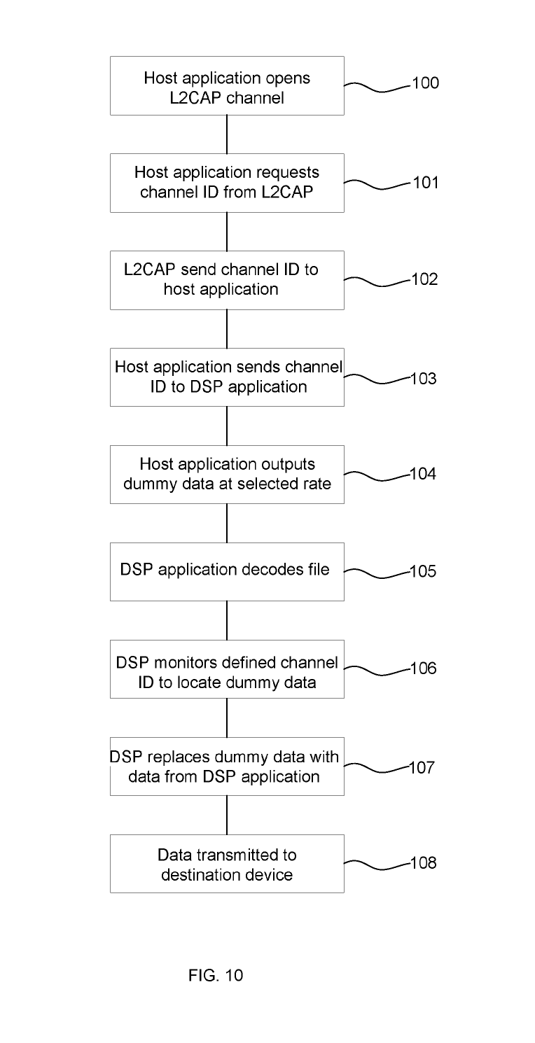

FIG. 10 shows a flow chart of a method, comparable to the method of FIG. 5, for performing the decoding and transmission of audio data using DSP 82 to perform the decoding steps in an efficient manner.

At block 100 the host application 83 opens an L2CAP link as described in relation to FIG. 9. At block 101 the host application 83 requests information from the L2CAP layer to allow the link that has been opened to be identified in the lower layers of the stack by the DSP 81. For example, the L2CAP channel identifier (CID) and the HCI ACL handle may be requested. The information is transmitted by the L2CAP layer to the host application, which then passes it on to the DSP application (Blocks 102, 103).

When all components are ready to commence decoding the audio file, the host application begins outputting dummy data at the rate identified in relation to FIG. 9 (Block 104) and the DSP application begins decoding the audio file (Block 105). Coordination of the start may be arranged by communication between the host and DSP applications. The dummy data may be random values or may have a predefined pattern. The DSP monitors the defined CID such that it can identify the data output from the host application (Block 106). The correct location for data replacement may be identified by matching the first four bytes of each L2CAP PDU to the header information expected for the particular CID.

At block 107 the DSP replaces the host application 83 data with the DSP application 86 data. The monitoring of Block 106 and replacement may be performed at any convenient layer of the Bluetooth stack on the DSP. For example, the Link Manager or Link Controller layers may be suitable.

The ‘real’ decoded audio data from the DSP application 86 has thus replaced the dummy data output by the host application 83 and the real data is transmitted to the destination device using the Bluetooth link (Block 108). Since the host application 83 and DSP application 86 were configured to output data at the same rate there is a direct replacement and the Bluetooth system is not affected by the replacement. Minimal modification of the operation of the Bluetooth stack is therefore required.

Control of the playback, for example pause or track skip, is performed by communication between the host application 83 and DSP application 86. The data that is written into the link from the DSP application 86 may include the L2CAP packet header information, or may be only the payload data. Since HCI packets may be smaller than L2CAP packets the DSP may need to interpret the HCI packet structure in order to ensure the data is placed in the correct location in each packet, which may vary between packets.

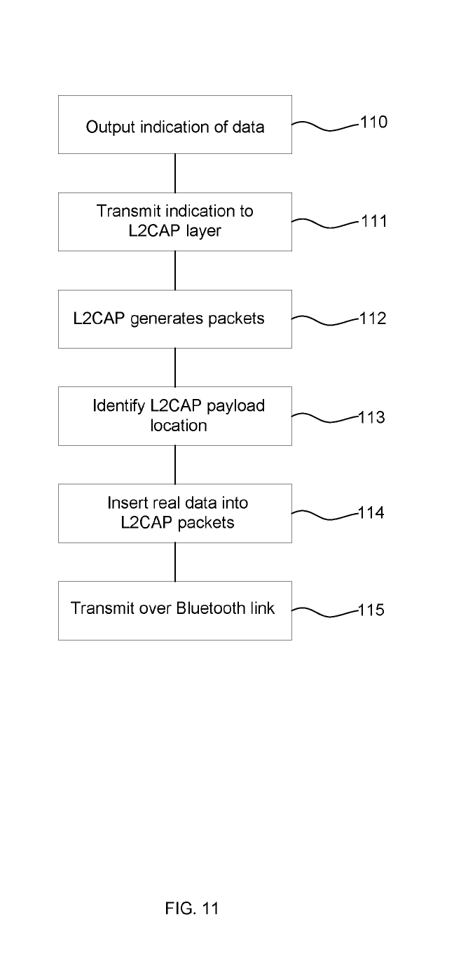

FIG. 11 shows a flow chart of a further method, comparable to the method of FIG. 6, for multiplexing data from the DSP application 86 into the Bluetooth stack for transmission.

In the method described in relation to FIG. 10 the host application outputs dummy data whose only purpose is to provide packets of the correct length for replacement by data from the DSP application. The dummy data is not used for any purpose and is discarded when it is replaced by the real data in the DSP. The method of FIG. 11 removes the transmission of dummy data by not outputting the data from the host application.

The method of FIG. 11 begins at the equivalent of Block 104 in FIG. 10, and as a precursor the steps of Blocks 100-103 will have been performed to open the Bluetooth link and provide the required channel identifiers in the same manner as described above.

At block 110, in place of outputting a certain amount of data, the host application outputs an indication of that amount of data. For example, if according to the output rates already defined the host application is due to output 600 bytes (including the L2CAP header which will be inserted by the L2CAP layer later), it actually outputs a token giving an indication of 600 bytes, but that token may only be a few bytes. At block 111 the token is transmitted to the L2CAP layer where it is received and its meaning interpreted. The L2CAP layer in this example is modified such that it can interpret the messages from the host application 83. In response to the token, at block 112, the L2CAP layer generates an appropriate number of HCI ACL packets. For example, if the host has indicated an output of 600 bytes, but the maximum ACL data packet length of the HCI ACL link is 300 bytes, two HCI packets are generated. The first packet is a start packet containing the L2CAP header and the second packet is a continuation packet containing zero bytes (since the data will be inserted by the DSP).

The HCI packets are passed through the Bluetooth stack to the layers in the DSP. This part of the Bluetooth stack does not require modification as the length indications at this layer match the actual data transmitted over HCI. However, this layer may be modified to read the L2CAP header data, which would normally be opaque at this level of the stack, such that enough space can be reserved in the buffer for the packets once they have expanded by the insertion of the DSP data.

At block 113 the DSP identifies the relevant packets, and the location where the payload should be, from the identification information previously passed from the host. At block 114 the DSP, or modified lower layer that is aware of what the DSP is doing, inserts the real data from the DSP application into the appropriate place in the L2CAP packets. The DSP, or the modified lower layer, must be aware that L2CAP packets on a particular channel will expand when the actual data is inserted. The DSP, or modified lower layer, must therefore reserve appropriate space in memory or buffers such that when that insertion occurs there is sufficient space for the larger packet without affecting any other data in the memory or buffer.

Since the host application output rate matches the DSP output rate, the packets will arrive for data insertion at the correct rate. At block 115 those packets are transmitted over the Bluetooth link to the destination device.

In an alternative implementation of FIG. 11, the host application may output the correct amount of data as per the method of FIG. 10, but the L2CAP layer may be configured to discard the information and simply send a packet header or token.

In the method of FIG. 11 the quantity of data transmitted through the stack below the L2CAP layer is reduced since no payload data is present until the DSP output is inserted into the data. The bandwidth of the HCI layer in particular is therefore reduced which may lead to power savings, or may allow high bandwidth application protocols to be run over low bandwidth HCI links.

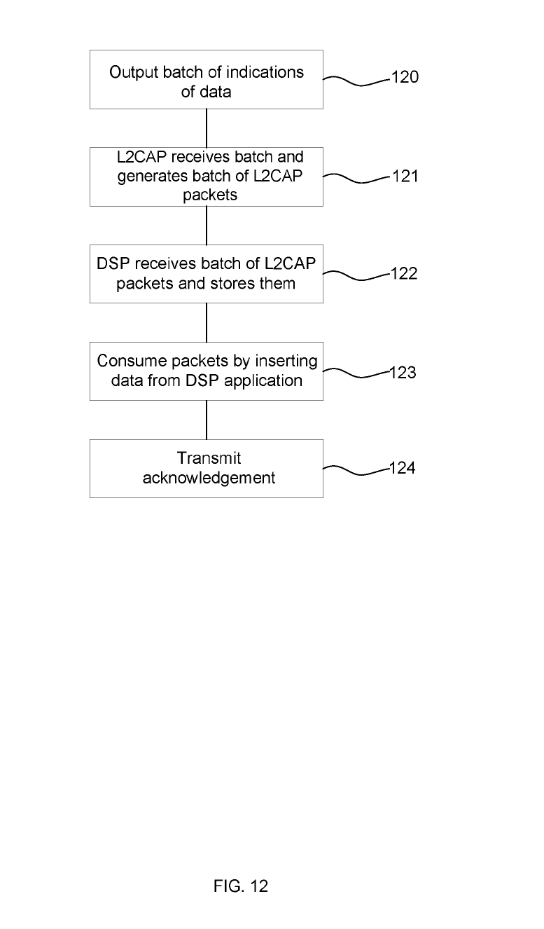

FIG. 12 shows a flow chart of a further method, comparable to the method of FIG. 7, for multiplexing data from the DSP application 82 into the Bluetooth stack for transmission.

In the method of FIG. 11, timing resided with the host application—the timing of tokens from the host application 83 matched the actual data output by the DSP application 86 and acknowledgements were passed back through the stack immediately. However, since no real data exists above the HCI, timing can be partially released by those upper layers, provided the average rate of packets arriving in the DSP 82 matches the output rate of the DSP application 86.

The method of FIG. 12 begins at the equivalent of Block 104 in FIG. 10, and as a precursor the steps of Blocks 100-103 will have been performed to open the Bluetooth link and provide the required channel identifiers in the same manner as described above.

At block 120, a token giving an indication of data to be output from the host application 83 is output. This is comparable to the token at block 110 of FIG. 11, but in contrast to the regular output in the method of FIG. 11, tokens in this method are batched together. For example, rather than outputting a token every 20 ms that the host application 83 is outputting 600 bytes, the host application 83 may output four such tokens once every 80 ms. The average data rate represented by the token is the same as that defined in the set up phase, but the spacing is irregular. Once a batch of tokens is output by the host application 83, the host application 83 may enter a low-power mode as no further action is required until a further batch of tokens is required.

At block 121 the batch of tokens is received by the L2CAP layer and an appropriate number of HCI packets is generated and released. In this example, with an MTU of 300 bytes, 8 packets may be released. Those packets are released as fast as the HCI, and other layers, allow and are not bound by the timing of the data from the DSP application.

At block 122 the L2CAP packets are received by the DSP 82 and stored. Appropriate space may be immediately reserved in the buffer or memory for the size of the packets resulting after insertion of the real data, or that may be done when each L2CAP packet is consumed. As data is output from the DSP application 86, the L2CAP packets are consumed by inserting payload data from the DSP application 86 as has been described previously (block 123). The average data rate indicated by the tokens output by the host application matches the data rate out of the DSP application 86 and therefore there will be the correct number of packets to allow continuous data transmission.

As packets are acknowledged by the controller at the remote device, acknowledgements (HCI Number of Completed Packets events) are not sent back to the host application 83, but are stored by the DSP 82 until the number of packets available to the DSP has reduced to a threshold. Once that threshold is reached a set of acknowledgments is sent to the host application 83 at block 124. Those acknowledgements trigger the next batch of tokens and the method repeats as described above.

The method of FIG. 12 operates in essentially the same manner as that of FIG. 11, but communications between the host 86 and DSP 82 are batched, thereby allowing the host 81 to sleep for extended periods between batches. A power saving may be made due to this ability to sleep. As the size of each batch is increased the periods available for sleep between these batches also increase. However, as described previously, increasing the number of HCI ACL packets released to the DSP reduces the ability for other applications to utilise the Bluetooth link, which may be undesirable. A balance must therefore be made between sleep periods and versatility.

In addition, for the same reason, if multiple applications are communicating with the same destination device, the method of FIG. 12 may not be appropriate as the L2CAP layer will want to share HCI ACL tokens between multiple links. These could be multiple L2CAP links to the same remote device, or multiple ACL links to different remote devices. In the latter case particularly, if the host allows all HCI ACL tokens to be used for one remote device and then that device goes out of range, it could be some time before the link times out and the tokens become available for other links. This sharing of tokens between multiple links is a normal feature of the L2CAP layer. Flow control management is still retained by the host. The number of tokens released is controlled by the host's knowledge of the size of the buffers in the controller and the receipt of acknowledgements. After the initial batch further tokens are only issued in response to acknowledgements, thus ensuring correct flow control.

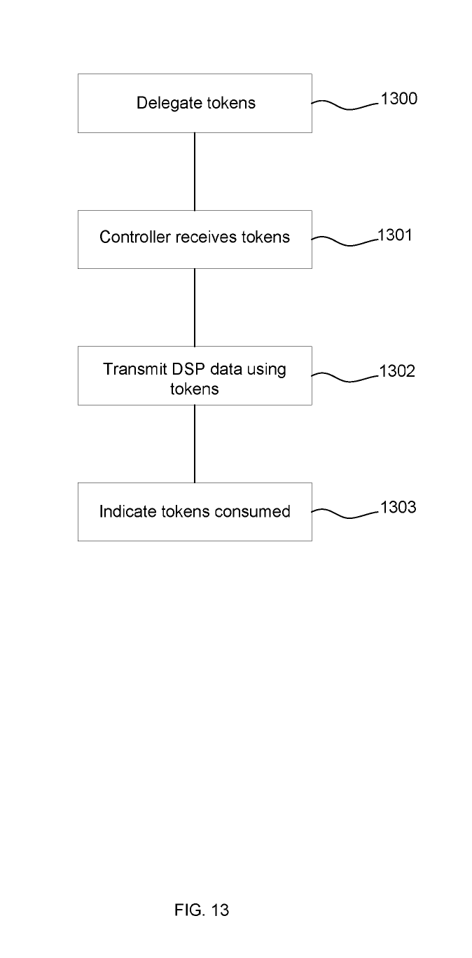

FIG. 13 shows a flow chart of a further method for multiplexing data into the Bluetooth stack where a greater degree of flow control is passed to the Bluetooth Controller.

In the methods described hereinbefore the number of tokens in circulation in the Bluetooth stack is controlled by the L2CAP layer and is managed such that the Bluetooth controller buffers cannot be overfilled, and such that the host has access to tokens to allow transmission of data from the host as well as from the DSP. The effect of this is that the number of tokens sent to the controller by the host is relatively limited and thus the periods for which the host can sleep between the transmission of batches of tokens is restricted. In the method of FIG. 13 the number of tokens delegated by the host to the controller is greater than the size of the buffers and therefore extended periods of sleep are possible between transmitting batches of tokens. This transfers a greater degree of flow control to the Bluetooth controller.

The method of FIG. 13 begins at the equivalent of Block 104 in FIG. 10, and as a precursor the steps of Blocks 100-103 will have been performed to open the Bluetooth link and provide the required channel identifiers in the same manner as described above.

At block 1300 the host delegates a number of tokens to the Bluetooth controller. The number of tokens delegated is selected such that the time taken to consume those tokens is significant and allows the host to sleep for an extended period. A further factor in the selection of the number of tokens delegated is how long it is desired to leave the controller to run autonomously. While the controller consumes the tokens the host is not able to transmit data over the Bluetooth link with regaining flow-control over the lower Bluetooth levels to ensure packets are interleaved correctly. The number of delegated tokens may therefore be selected such that the host can wait for the controller to consume all tokens before transmitting data. Alternatively, provision may be made to return tokens to the host before they are all consumed by the host.

At block 1301 the controller receives the tokens and records the number available. The controller accepts data from the DSP and proceeds to transmit that data using the delegated tokens (block 1302). Since the number of tokens is larger than can fill the buffers, flow control must be implemented in the controller to monitor the transmission of packets out of the buffers over the Bluetooth link and the receipt of acknowledgements. This flow control can be implemented using any applicable method.

As tokens are consumed no acknowledgements are sent back to the host and so the host does not need to be awake to perform any processing. Once the number of tokens available reduces to a predetermined level, an indication of this is returned to the host (block 1303). The host may then reclaim flow control and initiate the transmission of data from the host, or may delegate another set of tokens to the controller to restart the method at block 1300.

The tokens delegated from the host may contain the header information for each packet such that the controller populates the packets with the payload from the DSP. Alternatively the controller may generate the entire packet structure. Since only data from the DSP is being transmitted there is no requirement for spacing or slots to be provided for data from other sources to be transmitted and the data from the DSP is therefore transmitted in a continuous fashion. The controller can therefore take complete control of the transmission on the Bluetooth link.

The method of FIG. 13 could be operated in a closed-loop manner whereby the controller is delegated an infinite, or effectively infinite, number of tokens and arranges the transmission of data continuously without the need to report back to the host when its supply of tokens diminishes.

In the method of FIG. 13 the host cannot transmit data at arbitrary times as it has no flow-control over the transmission of packets. The ordering of L2CAP packets must be defined such that data from different sources is not confused. Since in this method the controller runs autonomously to simply consume the delegated tokens to transmit data, this ordering cannot be ensured. However, the method of FIG. 13 is contemplated for use where it is required to transmit large amounts of data and where there is no need for the host to also transmit data.

Since the host cannot transmit data at arbitrary times the upper layers of the stack must be modified such that they are aware when they can, and cannot, transmit data. Provision must also be made for the host to regain control of the controller should there be a need to transmit data.

A simple method to regain control would be to issue a flush command to the controller which would flush the buffers of data and return full control to the host. However, such a method would result in termination of the transmission of data from the DSP which may be undesirable. Any methods implemented to allow the host to reclaim control must be robust and ensure that no race conditions can occur between the host and controller.

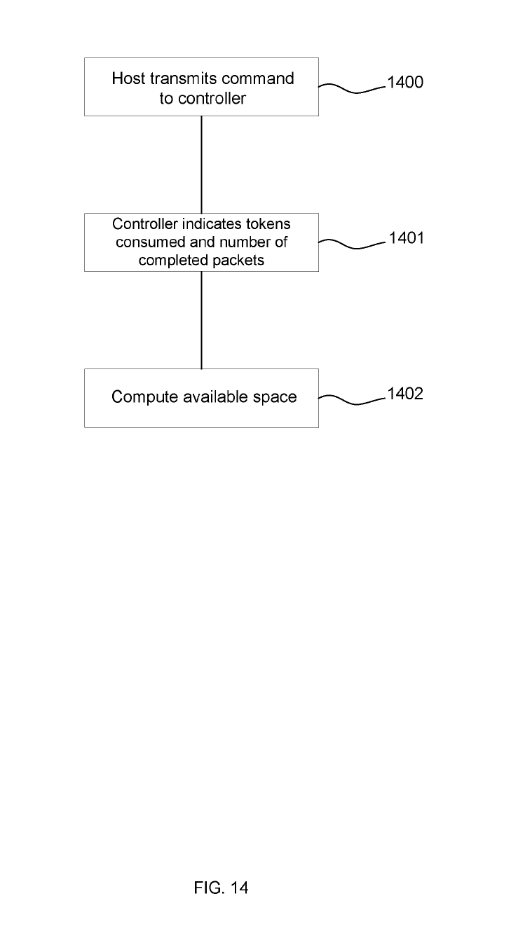

A method to regain control without terminating DSP transmission is to transition in a controlled manner back to the method described in relation to FIG. 12, as shown in FIG. 14.

At block 1400 the host requires control and issues a command to the controller. That command causes the controller to indicate to the host the number of tokens it has consumed and the number of completed packet indications it has received from the remote device (block 1401). The command to the controller may also indicate to the controller that it should not consume any further tokens.

The difference between the number of consumed tokens and the number of completed packets indicates the spare buffer space that is presently available in the controller. The host computes this value (Block 1402) and may begin to transmit its own data using the spare capacity. The host may also delegate further tokens (up to the number of spare buffers) to the controller to allow continuing transmission of data. The host and controller continue as per the method described in relation to FIG. 12. Careful control of the timing of the transition from FIG. 13 to FIG. 12 is required to ensure that both the host and controller have access to adequate tokens and that the flow of data is not compromised.

As will be appreciated by the skilled person the methods described above in relation to the decoding of an audio file may be applied to other functionality which requires the transmission of data over a Bluetooth link. The function may not be one that requires processing of data by the DSP, but could be, for example, the transmission of large amount of data from storage device 87 to a remote device. Such an application of the method would allow the host to sleep during the transmission thus saving power.

The use of the word multiplexing is not intended to indicate that there are necessarily multiple data streams through the Bluetooth system. Rather it is used as a convenient word to include insertion of a sole data stream or the multiplexing of data.

Suitable methods must be provided for use to terminate the process when the DSP ceases producing data for transmission, for example at the end of an audio track. Communication between the DSP and host, similar to that used during set up of the system, may be utilised to stop the generation of packets when the DSP has transmitted all of its data. In the later methods where a large number of tokens are delegated to the controller, the DSP may indicate to the host that it has used all of the tokens for which it has a requirement and returns the unneeded tokens to the host.

The description herein has been given in relation to implementation of the method in a Bluetooth. However, as will be appreciated by the skilled person, the invention is also applicable to other communications systems which use a similar stack structure to the Bluetooth structure. The Bluetooth stack is closely related to the OSI stack, as are many standard stack structures, and so it is likely that the invention could easily be transplanted to those other systems.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise and exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

What is claimed is:

1. A method for performance in a device having a first processing system for providing the functionality of the upper layers of a Bluetooth stack and a Bluetooth Controller for providing the functionality of the lower layers of the Bluetooth stack, the first processing system and the Bluetooth Controller being connected by a Host Controller Interface (HCI), the method comprising the steps of
generating L2CAP packets in the L2CAP layer of the Bluetooth stack in the first processing system corresponding to an Asynchronous Connectionless (ACL) link,
transmitting those L2CAP packets through the Bluetooth stack to the Bluetooth Controller via the HCI,
inserting data generated in a second processing system into the L2CAP packets in the Bluetooth Controller, and
transmitting the L2CAP packets over the ACL link.

2. A method according to claim 1, wherein inserting data comprises overwriting existing payload data.

3. A method according to claim 1, wherein inserted data comprises adding payload data to existing header data.

4. A method according to claim 1 wherein the L2CAP packets are generated to transport data output by an application on the first processing system.

5. A method according to claim 4, wherein the data output from the application on the first processing system is at a rate and timing to match the data generated in the second processing system.

6. A method according to claim 4, wherein the data output from the application on the first processing system is at an average data rate equal to the average data rate of the data generated by the DSP.

7. A method according to claim 1, wherein the capacity and timing of the L2CAP packets matches the timing and rate of the data generated by the DSP.

8. A method according to claim 1, wherein the average capacity over time of the L2CAP packets matches the average data rate of the data generated by the DSP.

9. A method according to claim 8, wherein the L2CAP packets are generated in batches.

10. A method according to claim 9, wherein the number of L2CAP packets generated in a batch is less than the permissible number of L2CAP packets, as determined by flow control in layers beneath L2CAP.

11. A method according to claim 9, wherein the number of L2CAP packets generated in a batch is in excess of the capacity of the transmission buffers in the Bluetooth controller.

12. A method according to claim 1, wherein the data generated on the DSP is decoded audio data generated by decoding an audio file.

13. A method according to claim 1, wherein the first processing system is a host processor.

14. A method according to claim 1, wherein a user interface and control functions of a music decoding system are provided by the first processing system.

15. A method according to claim 14, further comprising the step of the first processing system opening the ACL link to which the L2CAP packets relate and indicating the identity of that ACL link to the DSP.

16. A method according to claim 15, wherein the L2CAP packets for insertion into are identified by comparison of the L2CAP header information with the identity of the ACL link transmitted to the DSP.
